(19) United States
(12) Patent Application Publication
(10) Pub. No.: US 2026/0108414 A1
(43) Pub. Date: Apr. 23, 2026

(54) KNEADING AND TAPPING MASSAGER AND MASSAGE MACHINE CORE THEREOF

(71) Applicant: Xiamen High Top Electronic Technology Co.,Ltd., XIAMEN (CN)

(72) Inventors: Liangsan ZHAO, XIAMEN (CN); Chengxian CHEN, XIAMEN (CN)

(73) Assignee: Xiamen High Top Electronic Technology Co.,Ltd., XIAMEN (CN)

(21) Appl. No.: 18/961,494

(22) Filed: Nov. 27, 2024

(30) Foreign Application Priority Data
Oct. 17, 2024 (CN) 2024114551323

(51) Int. Cl. A61H 7/00; A61H 15/00

(52) U.S. Cl. CPC A61H 7/007; A61H 15/0078

(57) ABSTRACT

A kneading and tapping massager and a massage machine core thereof are provided, the massage machine core includes a machine core shell, a motor, a first transmission mechanism, a second transmission mechanism, a kneading shaft, kneading modules, a tapping shaft, tapping modules, a connecting shaft, a central plate, and a battery, the motor drives the first transmission mechanism and the second transmission mechanism, the kneading module is arranged on the kneading shaft, the tapping module is arranged on the tapping shaft, the first transmission mechanism is connected with the kneading shaft, the second transmission mechanism is connected with the tapping shaft, the first transmission mechanism drives the kneading shaft to rotate, so that the kneading module arranged on the kneading shaft to perform a kneading action, the second transmission mechanism drives the tapping shaft to rotate, the tapping module arranged on the tapping shaft performs a tapping action.

### CROSS REFERENCE TO THE RELATED APPLICATIONS

This application is based upon and claims priority to Chinese Patent Application No. 202411455132.3, filed on Oct. 17, 2024, the entire contents of which are incorporated herein by reference.

### TECHNICAL FIELD

The present disclosure relates to the technical field of massagers, in particular to a kneading and tapping massager and a massage machine core thereof.

### BACKGROUND

In modern society, due to prolonged sitting in offices for work, classrooms for study, and dormitories or homes for playing on computers and mobile phones day in and day out, many people inevitably suffer from cervical spondylosis and periarthritis of the shoulder. In response to this, shoulder strap massagers designed for massaging the shoulders and neck have emerged. Shoulder strap massagers are mainly used to massage the user's shoulder and neck areas. During use, the driving device provides mechanical kinetic energy to the massage mechanism, enabling it to relieve muscle tension, improve blood circulation in the shoulder and neck, and alleviate stiffness and pain in the shoulder and neck muscles through regular rotation, swing, vibration, tapping, and other methods.

Currently, the more common massagers can be divided into kneading massagers and tapping massagers based on their functions. However, the kneading massagers and tapping massagers in the prior art generally only have a single function, namely, the kneading massagers only have the function of kneading massage, and the tapping massagers only have the function of tapping massage, which is difficult to meet users' needs. Although some massagers currently available have achieved the dual function of kneading and tapping, their structures are relatively complex, bulky, and costly. In addition, the kneading and tapping functions of many massagers can only work independently and cannot work simultaneously, resulting in poor massage effects.

In view of the above, the present disclosure has been developed by in-depth contemplation of the disadvantages and inconveniences caused by the unperfect design of the existing massage machine core, and by rigorous research, improvements, and trials.

### SUMMARY

An object of the present disclosure is to overcome the disadvantages of the prior art and to provide a massage machine core which is compact in structure and has both kneading and tapping functions.

In order to achieve the above object, the solution of the present disclosure is:
a massage machine core includes a machine core shell, having a battery and a central plate arranged therein;
a motor, arranged in the machine core shell, the motor having an output shaft;
a first transmission mechanism, connected with the output shaft of the motor and a kneading shaft;
a second transmission mechanism, connected with the output shaft of the motor or the first transmission mechanism, wherein the second transmission mechanism includes a multi-wedge belt, a one-way needle roller bearing pulley, a one-way needle roller bearing and a small pulley, the one-way needle roller bearing is arranged on a connecting shaft, the one-way needle roller bearing pulley sleeves the one-way needle roller bearing, the small pulley is arranged on a tapping shaft, one end of the multi-wedge belt sleeves the one-way needle roller bearing pulley, and the other end sleeves the small pulley;
the kneading shaft, arranged in the machine core shell and connected with the first transmission mechanism;
two kneading modules, symmetrically arranged at two ends of the kneading shaft;
the tapping shaft, arranged within the machine core shell and connected with the second transmission mechanism;
two tapping modules, symmetrically arranged at two ends of the tapping shaft and each connected with the kneading module on the same side; and
the connecting shaft, arranged in parallel with the tapping shaft at an interval and connected with the first transmission mechanism or the output shaft of the motor.

Further, the kneading module includes an eccentric wheel, a deflection wheel, a first massage head bracket, a second massage head bracket, a first massage head, and a second massage head, the eccentric wheel and the deflection wheel are fixedly arranged on the kneading shaft, the first massage head bracket rotatably sleeves the eccentric wheel or the deflection wheel, the second massage head bracket rotatably sleeves the deflection wheel or the eccentric wheel, a deflection slope between the first massage head bracket and the second massage head bracket is thin on one side and thick on the other side; a top end of the first massage head bracket is provided with the first massage head, a bottom end of the first massage head bracket is provided with a gimbal; a top end of the second massage head bracket is provided with the second massage head, a bottom end of the second massage head bracket is provided with a limit post, the machine core shell is provided with a limit seat at a position corresponding to the limit post, and a limit groove is arranged on the limit seat for the limit post to move; and
the tapping module includes a tapping seat and a tapping rod, the tapping seat is eccentrically arranged on the tapping shaft corresponding to the first massage head bracket, one end of the tapping rod is connected with the tapping seat, the other end is provided with a gimbal ball, the gimbal ball is rotatably arranged on the gimbal at the bottom of the first massage head bracket.

Further, the first transmission mechanism includes a triple gear, a transmission gear, a kneading gear and a tapping gear, the triple gear includes a helical gear engaged with the output shaft, a first spur gear engaged with the transmission gear and a second spur gear engaged with the kneading gear, the kneading gear is fixedly connected with the kneading shaft, the transmission gear includes a third spur gear engaged with the first spur gear and a fourth spur gear engaged with the tapping gear, and the tapping gear is fixed on the connecting shaft.

Further, the eccentric wheel is fixedly arranged on a side of the kneading shaft close to the center, the first massage head bracket sleeves the eccentric wheel, the deflection wheel abuts on the kneading shaft outside the eccentric wheel, so that the first massage head bracket is limited on the eccentric wheel, the second massage head bracket sleeves the deflection wheel, an outer end of the deflection wheel is limited by a deflection wheel fixing seat, so that the second massage head bracket is limited on the deflection wheel, and the deflection wheel between the first massage head bracket and the second massage head bracket forms the deflection slope.

Further, the gimbal at the bottom of the first massage head bracket is a split structure including a left gimbal and a right gimbal directly integrally formed or fixedly arranged with the first massage head bracket, a ball hole for the gimbal ball of the tapping rod to fit is provided between the left gimbal and the right gimbal, and the gimbal ball is mounted in the ball hole.

Further, the tapping seat of the tapping module is provided with a mounting hole, the mounting hole sleeves a bearing, the bearing is arranged on the tapping shaft, the tapping seat is provided with a connecting seat, the connecting seat is provided with a pivoting groove where one end of the tapping rod is rotatably connected, the one end of the tapping rod is rotatably mounted on the pivoting groove through a pivoting shaft.

Further, the first massage head is detachably arranged on the first massage head bracket, an end of the first massage head bracket is provided with a first insertion post, a bottom end of the first massage head is provided with a first insertion hole corresponding to the first insertion post, so that the first massage head bracket and the first massage head are detachably fitted together; the second massage head is detachably arranged on the second massage head bracket, a top end of the second massage head bracket is provided with a second insertion post, a bottom end of the second massage head is provided with a second insertion hole corresponding to the second insertion post, so that the second massage head bracket and the second massage head are detachably fitted together.

Further, the machine core shell includes an outer upper shell, an outer lower shell, an inner upper shell and an inner lower shell, the outer upper shell and the outer lower shell are buckled together, the inner upper shell and the inner lower shell are buckled together, and the inner upper shell and the inner lower shell are arranged at a middle position within the outer upper shell and the outer lower shell, and the motor is mounted within the inner upper shell and the inner lower shell.

Further, the outer upper shell of the machine core shell is provided with four massage head holes for the first massage heads and the second massage heads to protrude out, the four massage head holes are provided with buffer sleeves respectively, and the first massage heads and the second massage heads protrude out of the buffer sleeves.

Another object of the disclosure is to overcome the shortcomings of the prior art by providing a compact kneading and tapping massager with both kneading and tapping functions.

To achieve the aforementioned object, the solution proposed by the disclosure is as follows:
a kneading and tapping massager includes the massage machine core, handle cloth covers, adjusting belts and a control switch, wherein each side of the massage machine core is connected with the handle cloth cover, and the control switch is arranged on one of the handle cloth covers and connected with the central plate in the massage machine core, and the adjusting belt is arranged on the handle cloth cover.

Further, two sides of the machine core shell of the massage machine core are provided with connecting pieces, the handle cloth sleeve is fixedly connected with the connecting piece, the adjusting belt is an elastic belt, one end of the elastic belt is fixed with the handle cloth sleeve, and the other end is provided with a mating male or female buckle.

With the adoption of the aforementioned structure, during the operation of the massage machine core of the disclosure, the motor operates to drive the rotation of the first transmission mechanism and the second transmission mechanism. The first transmission mechanism drives the rotation of the kneading shaft, the eccentric wheel, and the deflection wheel, which in turn drive the rotation of the first massage head bracket and the second massage head bracket. The one-way needle roller bearing of the second transmission mechanism will choose to be stuck or rotate depending on the direction of rotation of the motor. When the one-way needle roller bearing is stuck, the second transmission mechanism transmits at the same speed as the first transmission mechanism, so that the first massage head bracket and the second massage head bracket drive the first massage head and the second massage head to move synchronously to carry out the massage action of kneading and clamping, and the tapping module does not carry out the tapping action; when the one-way needle roller bearing rotates, the multi-wedge belt is driven to accelerate transmission, so that the tapping rod drives the first massage head bracket and the first massage head to accelerate up-down swing, and the tapping action is carried out simultaneously in addition to the massage action of clamping and kneading by the second massage head. The massage machine core of the disclosure can simultaneously drive the first massage head bracket and the second massage head bracket to carry out left-right and up-down deflection actions through a motor, so that the first massage head and the second massage head can complete the kneading and clamping action, and whether or not to perform the tapping action while applying kneading and clamping massage can be selected through the forward or reverse rotation of the motor. The overall structure is compact, the manufacturing cost is low, and the market competitiveness can be improved.

### BRIEF DESCRIPTION OF THE DRAWINGS

FIG. 1 is an exploded schematic view of the kneading and tapping massager according to the present disclosure.

FIG. 2 is a schematic view of the combined appearance of the kneading and tapping massager according to the present disclosure.

FIG. 3 is a perspective view of the appearance of the massage machine core according to the present disclosure.

FIG. 4 is a schematic view of a partial structure of the massaging machine core according to the present disclosure.

FIG. 5 is a plan view of the massage machine core in an open state during use when the motor rotates forward according to the present disclosure.

FIG. 6 is a side view of the massage machine core in an open state during use when the motor rotates forward according to the present disclosure.

FIG. 7 is a plan view of the massage machine core in a closed state during use when the motor rotates forward according to the present disclosure.

FIG. 8 is a side view of the massage machine core in a closed state during use when the motor rotates forward according to the present disclosure.

FIG. 9 is a plan view of the massage machine core in an open state during use when the motor rotates backward according to the present disclosure.

FIG. 10 is a side view of the massage machine core in an open state during use when the motor rotates backward according to the present disclosure.

FIG. 11 is a plan view of the massage machine core in a closed state during use when the motor rotates backward according to the present disclosure.

FIG. 12 is a side view of the massage machine core in a closed state during use when the motor rotates backward according to the present disclosure.

FIG. 13 is a schematic cross-sectional view of the position of the kneading shaft of the massage machine core according to the present disclosure.

FIG. 14 is a schematic cross-sectional view of the position of the tapping shaft of the massage machine core according to the present disclosure.

FIG. 15 is a schematic cross-sectional view of the position of the gimbal of the massage machine core according to the present disclosure.

FIG. 16 is a schematic view of the transmission structure of the massage machine core according to the present disclosure.

FIG. 17 is an exploded view of the kneading module and the tapping module of the massage machine core according to the present disclosure.

### DESCRIPTION OF REFERENCE SIGNS

10. massage machine core; 1. machine core shell; 11. outer upper shell; 111. massage head hole; 112. buffer sleeve; 12. outer lower shell; 13. inner upper shell; 14. inner lower shell; 15. limit seat; 16. limit groove; 2. motor; 21. output shaft; 3. first transmission mechanism; 31. triple gear; 311. helical gear; 312. first spur gear; 313. second spur gear; 32. transmission gear; 321. third spur gear; 322. fourth spur gear; 33. kneading gear; 34. tapping gear; 4. second transmission mechanism; 41. multi-wedge belt; 42. one-way needle roller bearing pulley; 43. one-way needle roller bearing; 44. small pulley; 5. kneading shaft; 6. kneading module; 61. eccentric wheel; 62. deflection wheel; 621, deflection slope; 63. first massage head bracket; 631. gimbal; 632. first insertion post; 633. left gimbal; 634. right gimbal; 635. ball hole; 64. second massage head bracket; 641. limit post; 642. second insertion post; 65. first massage head; 651. first insertion hole; 66. second massage head; 661. second insertion hole; 67. deflection wheel fixing seat; 7. tapping shaft; 8. tapping module; 81. tapping seat; 811. mounting hole; 812. connecting seat; 813. pivoting groove; 814. pivoting shaft; 82. tapping rod; 821. gimbal ball; 83. bearing; 9. connecting shaft; 20. handle cloth cover; 30. adjusting belt; 40. control switch.

### DETAILED DESCRIPTION OF THE EMBODIMENTS

In order to further explain the technical solutions of the present disclosure, the present disclosure will be described in detail below with reference to specific embodiments.

In the description of the disclosure, it needs to be understood that the terms “central”, “longitudinal”, “lateral”, “up”, “down”, “front”, “back”, “left”, “right”, “vertical”, “horizontal”, “top”, “bottom”, “inner”, “outer”, and the like indicate an orientation or positional relationship based on that shown in the drawings, merely for ease of description of the disclosure and simplification of the description, it is not intended to indicate or imply that the device or element referred to must have, be constructed and operate in a particular orientation, and therefore should not be construed as limiting the disclosure. In the description of the present disclosure, unless otherwise specified, “a plurality of” means two or more.

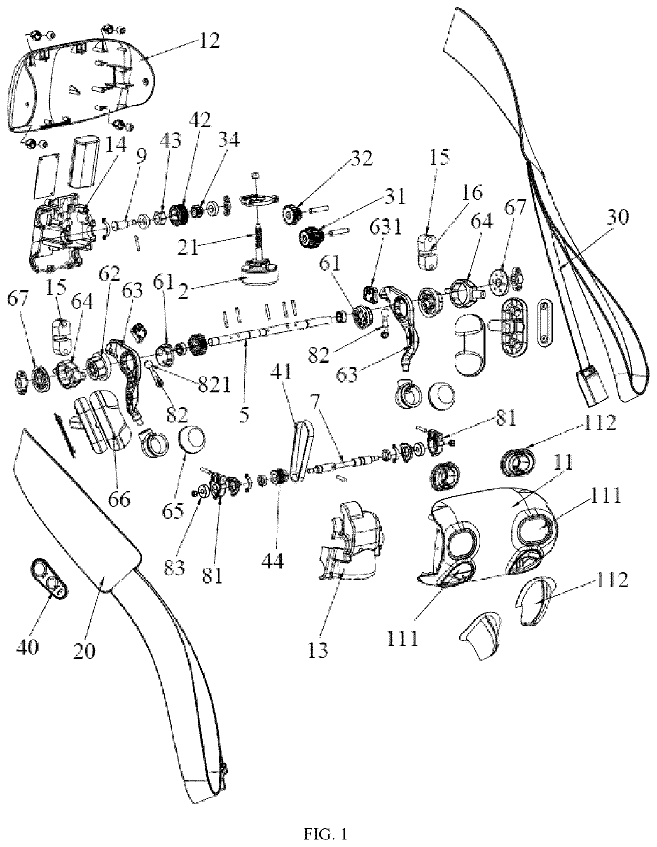

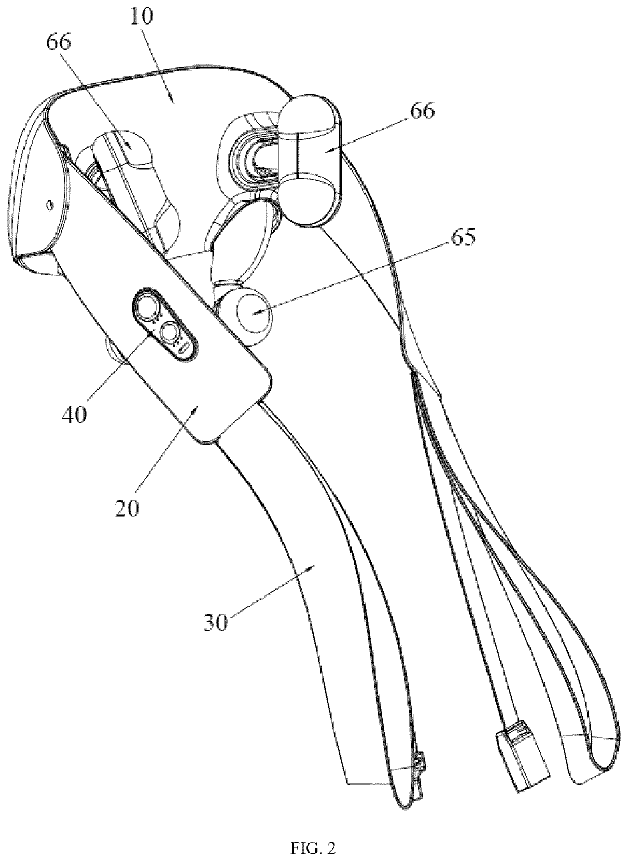

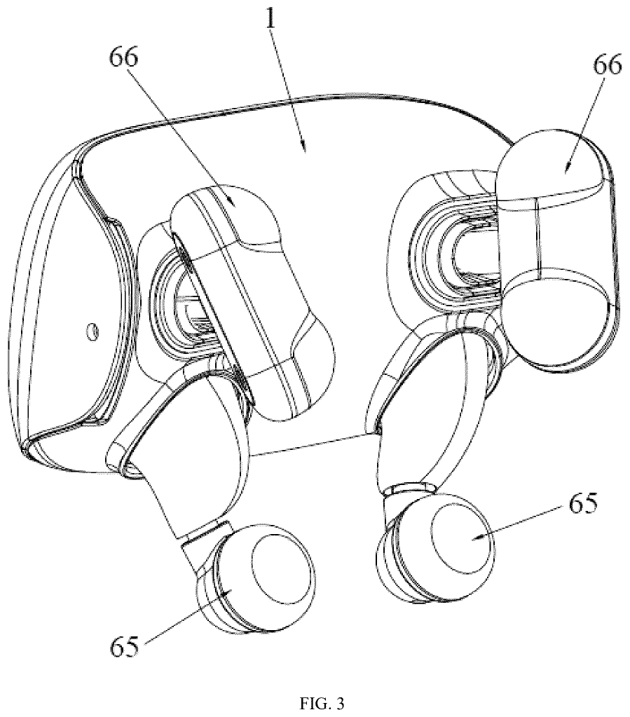

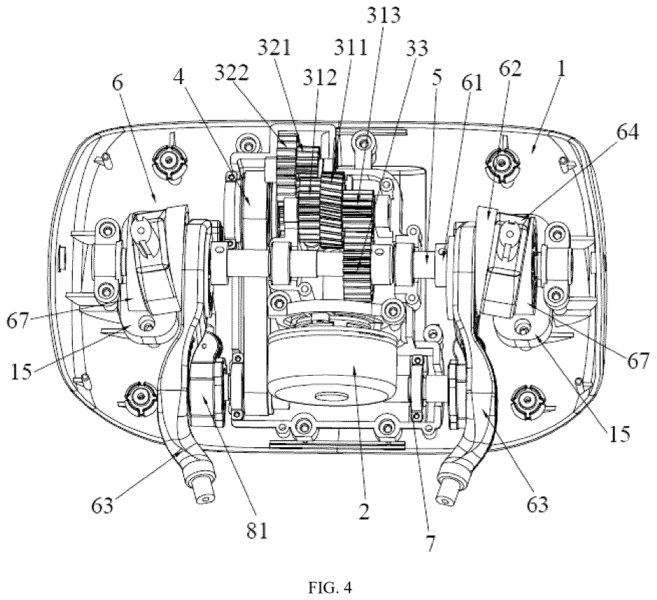

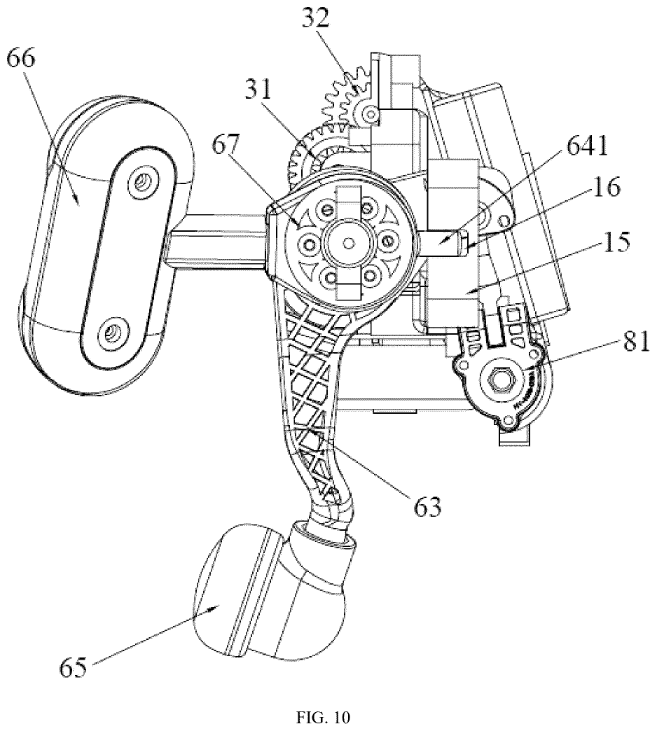

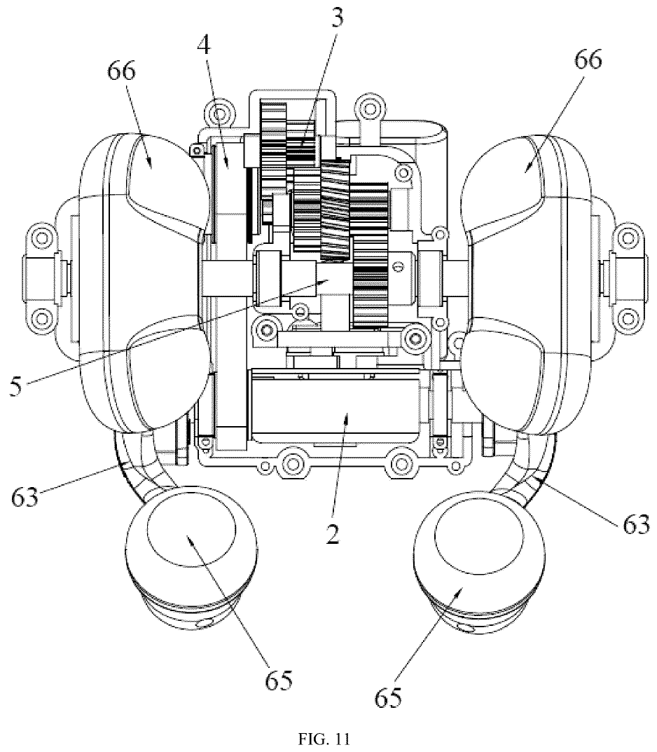

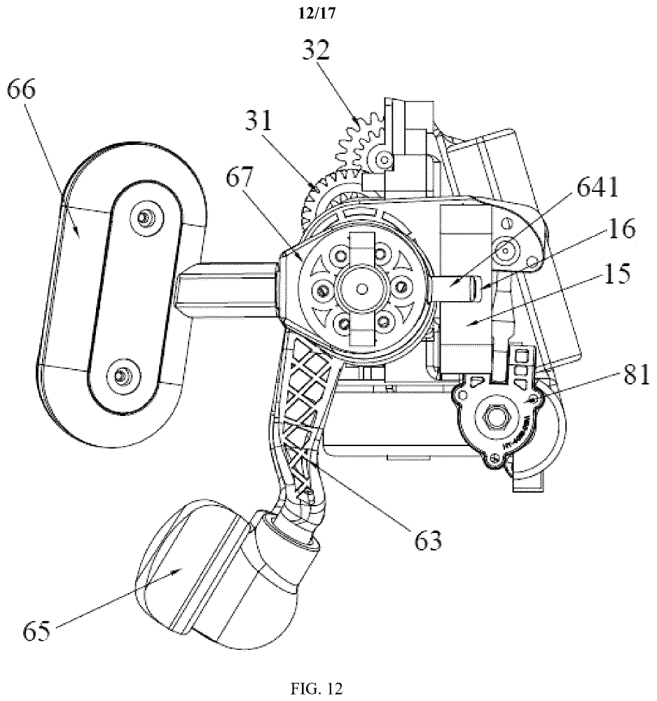

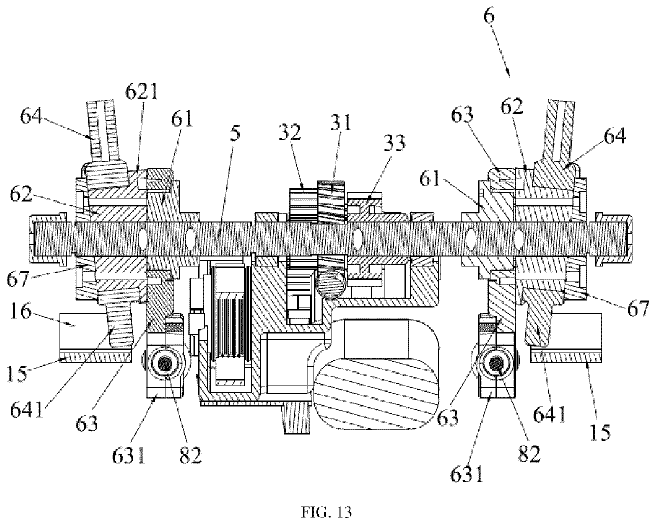

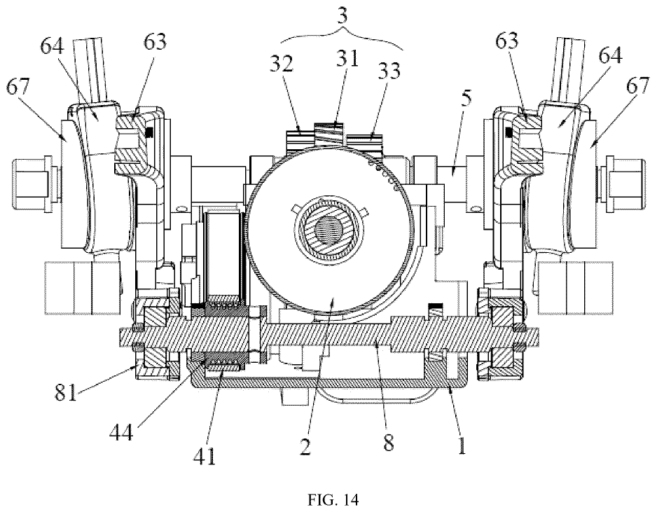

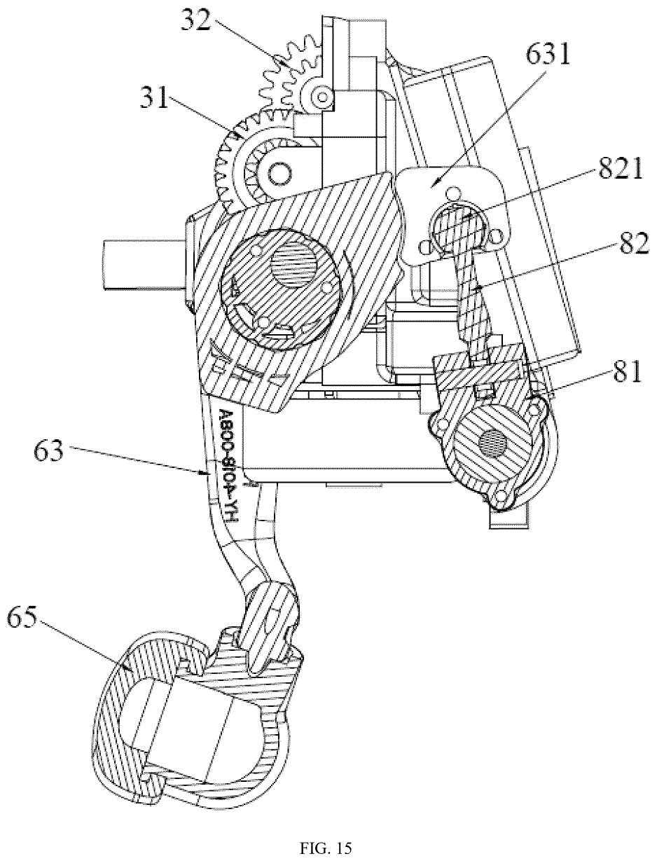

As shown in FIGS. 1-17, the disclosure discloses a kneading and tapping massager, which includes a massage machine core 10, handle cloth covers 20, adjustment belts 30 and a control switch 40. Each side of the massage machine core 10 is connected with the handle cloth cover 20, and the control switch 40 is arranged on one of the handle cloth covers 20 and connected with the central plate in the massage machine core 10. The adjusting belt 30 is arranged on the handle cloth cover 20. In this embodiment, the adjusting band 30 is an elastic band, one end of the elastic belt is fixed with the handle cloth sleeve 20, and the other end is provided with a mating male or female buckle.

The massage machine core 10 includes a machine core shell 1, a motor 2, a first transmission mechanism 3, a second transmission mechanism 4, a kneading shaft 5, kneading modules 6, a tapping shaft 7, tapping modules 8, a central plate 8, and a battery. The motor 2 drives the first transmission mechanism 3 and the second transmission mechanism 4, and the kneading module 6 is arranged on the kneading shaft 5. The tapping module 8 is arranged on the tapping shaft 7. The first transmission mechanism 3 is connected with the kneading shaft 5, and the second transmission mechanism 4 is connected with the tapping shaft 7. The motor 2 operates to drive the first transmission mechanism 3 and the second transmission mechanism 4 to operate. The first transmission mechanism 3 drives the kneading shaft 5 to rotate, so that the kneading module 6 arranged on the kneading shaft 5 to perform a kneading action. The second transmission mechanism 4 drives the tapping shaft 7 to rotate, so that the tapping module 8 arranged on the tapping shaft 7 performs a tapping action.

The machine core shell 1 includes an outer upper shell 11, an outer lower shell 12, an inner upper shell 13 and an inner lower shell 14. The outer upper shell 11 and the outer lower shell 12 are buckled together, and the inner upper shell 13 and the inner lower shell 14 are buckled together. The inner upper shell 13 and the inner lower shell 14 are arranged at a middle position within the outer upper shell 11 and the outer lower shell 12, and the motor 2 is mounted within the inner upper shell 13 and the inner lower shell 14. One end of the motor 2 is provided with a threaded output shaft 21, the output shaft 21 is connected to the first transmission mechanism 3 and/or the second transmission mechanism 4. The first transmission mechanism 3 and the second transmission mechanism 4 can be directly or indirectly driven by the output shaft 21, the first transmission mechanism 3 is connected with the kneading shaft 5, and the second transmission mechanism 4 is connected with the tapping shaft 7. The kneading module 6 is arranged on the kneading shaft 5, and the tapping module 8 is arranged on the tapping shaft 7.

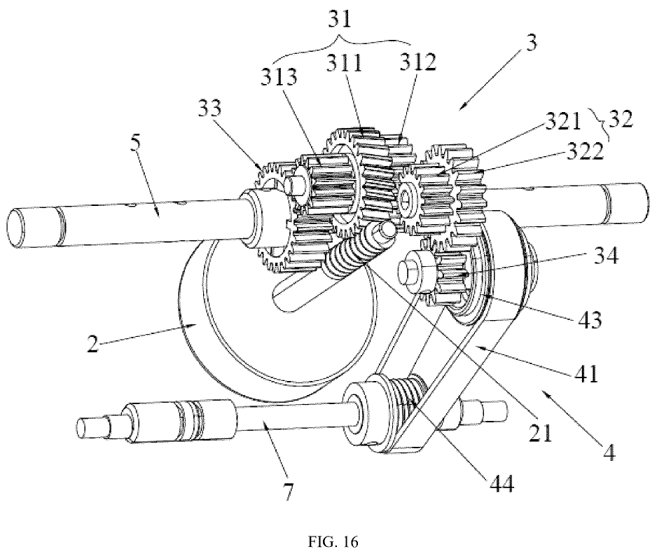

As shown in FIG. 16, in the present embodiment, the first transmission mechanism 3 includes a triple gear 31, a transmission gear 32, a kneading gear 33 and a tapping gear 34, and the triple gear 31 includes a helical gear 311 engaged with screw teeth of the output shaft 21, a first spur gear 312 engaged with the transmission gear 32 and a second spur gear 313 engaged with the kneading gear 33. The kneading gear 33 is fixedly connected with the kneading shaft 5, and the transmission gear 32 includes a third spur gear 321 engaged with the first spur gear 312 and a fourth spur gear 322 engaged with the tapping gear 34. The first transmission mechanism 3 and the second transmission mechanism 4 are connected through the connecting shaft 9, and the tapping gear 34 is fixed on the connecting shaft 9.

The second transmission mechanism 4 includes a multi-wedge belt 41, a one-way needle roller bearing pulley 42, a one-way needle roller bearing 43 and a small pulley 44. The one-way needle roller bearing 43 is arranged on the connecting shaft 9 where the tapping gear 34 is fixed, and the one-way needle roller bearing pulley 42 sleeves the one-way needle roller bearing 43. The small pulley 44 is arranged on the tapping shaft 7, one end of the multi-wedge belt 41 sleeves the one-way needle roller bearing pulley 42, and the other end sleeves the small pulley 44.

The first transmission mechanism 3 and the second transmission mechanism 4 may have various transmission ways, and for example, output shafts 21 may be provided at both ends of the motor 2, wherein one output shaft 21 is connected with the first transmission mechanism 3 and the other output shaft 21 is connected with the second transmission mechanism 4. Of course, the corresponding transmission gears need to be correspondingly modified, and the above is only a specific embodiment of the present application.

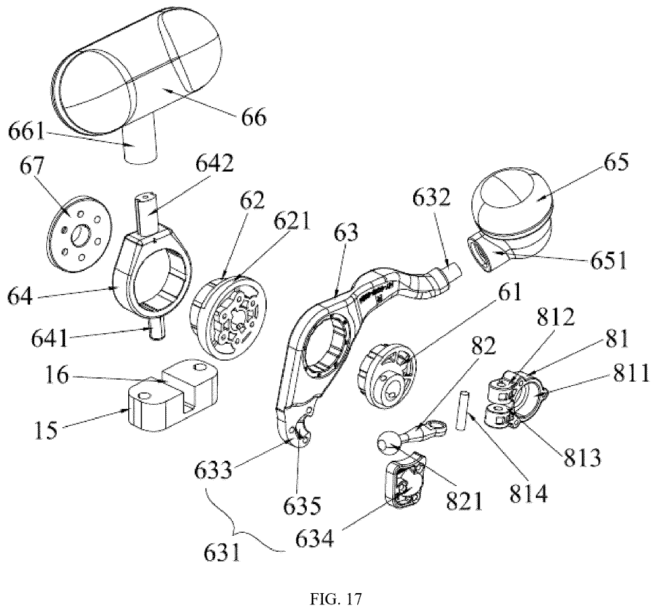

As shown in FIG. 17, the kneading module 6 includes an eccentric wheel 61, a deflection wheel 62, a first massage head bracket 63, a second massage head bracket 64, a first massage head 65, and a second massage head 66, and a central portion of the kneading shaft 5 is provided with the kneading gear 33. Two sides of the kneading shaft 5 are symmetrically provided with the kneading modules 6, and the eccentric wheel 61 is fixedly arranged on the kneading shaft 5. The first massage head bracket 63 sleeves the eccentric wheel 61, the deflection wheel 62 is arranged on the kneading shaft 5 outside the eccentric wheel 61, so that the first massage head bracket 63 is limited on the eccentric wheel 61. The second massage head bracket 64 sleeves the deflection wheel 62, and an outer end of the deflection wheel 62 is limited by a deflection wheel fixing seat 67, so that the second massage head bracket 64 is limited on the deflection wheel 62. The deflection wheel 62 between the first massage head bracket 63 and the second massage head bracket 64 forms the deflection slope 621 which is thin on one side and thick on one side. A top end of the first massage head bracket 63 is provided with the first massage head 65, and a bottom end of the first massage head bracket 63 is provided with a gimbal 631. A top end of the second massage head bracket 64 is provided with the second massage head 66, and a bottom end of the second massage head bracket 64 is provided with a limit post 641. The machine core shell 1 is provided with a limit seat 15 at a position corresponding to the limit post 641, a limit groove 16 is arranged on the limit seat 15 for the limit post 641 to move, and the limit post 641 is movably arranged in the limit groove 16.

As shown in FIG. 17, the tapping module 8 includes a tapping seat 81 and a tapping rod 82, and two tapping seats 81 are flatly arranged on both sides of the tapping shaft 7 at positions corresponding to the first massage head brackets 63. One end of the tapping rod 82 is connected with the tapping seat 81, and the other end is provided with a gimbal ball 821. The gimbal ball 821 is rotatably arranged on the gimbal 631 at the bottom of the first massage head bracket 63.

The working principle of the massage machine core 10 of the present disclosure is illustrated by the embodiment shown in FIGS. 1-17:

When the motor 2 rotates in a forward direction, the output shaft 21 of the motor 2 drives the triple gear 31 to rotate. One end of the triple gear 31 drives the kneading shaft 5 to rotate, which in turn drives the eccentric wheel 61 and the deflection wheel 62 to rotate. This, in turn, drives the first massage head bracket 63 and the second massage head bracket 64 to rotate. The limit post 641 at the bottom of the second massage head bracket 64, under the limiting action of the limit groove 16 in the limit seat 15, allows the second massage head 66 on the second massage head bracket 64 to perform a deflection action within a certain range. Meanwhile, the first massage head bracket 63 is constrained by the tapping rod 82 connected to the gimbal 631 of the first massage head bracket 63 and the deflection slope 621 of the deflection wheel 62, enabling the first massage head 65 on the first massage head bracket 63 to perform a swing action as the kneading shaft 5 rotates. Together with the second massage head 66 on the second massage head bracket 64, this achieves a kneading and clamping massage effect. At the same time, the other end of the triple gear 31 drives the tapping gear 34 and the connecting shaft 9 to rotate. At this point, the one-way needle roller bearing 43 is stuck, and the multi-wedge belt 41 rotates normally downwards. Since the one-way needle roller bearing 43 prohibits transmission, the gimbal 631 connected to the tapping rod 82 synchronously performs an up-down swing action. The transmission speed of the second transmission mechanism 4 remains consistent with that of the first transmission mechanism 3. In other words, when the motor 2 rotates forward, only the kneading and clamping actions are performed, and no tapping action is carried out.

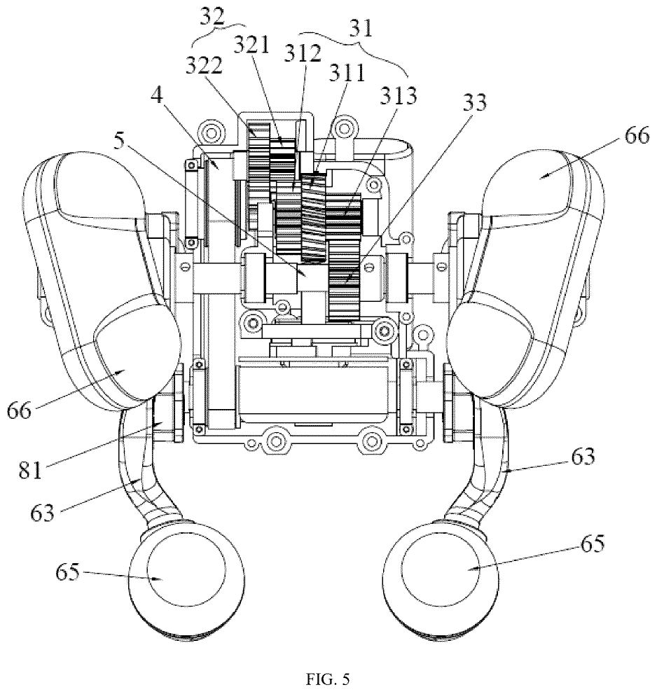

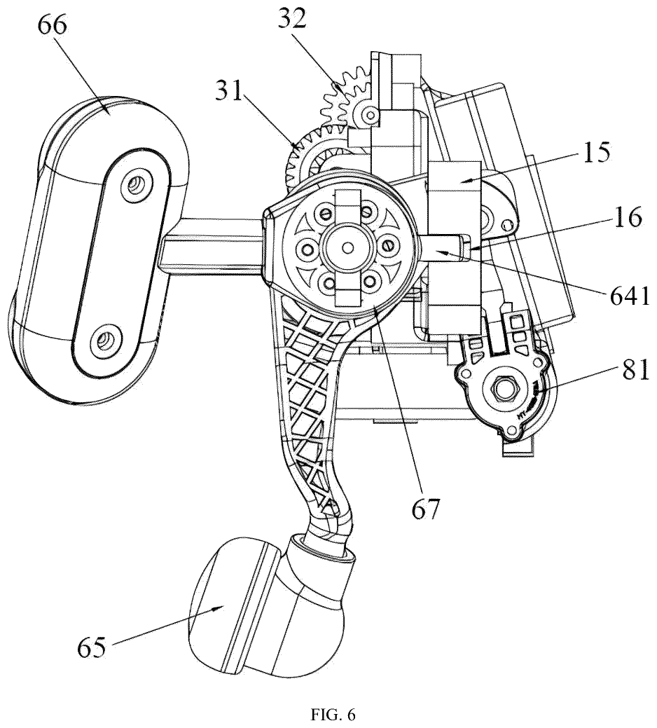

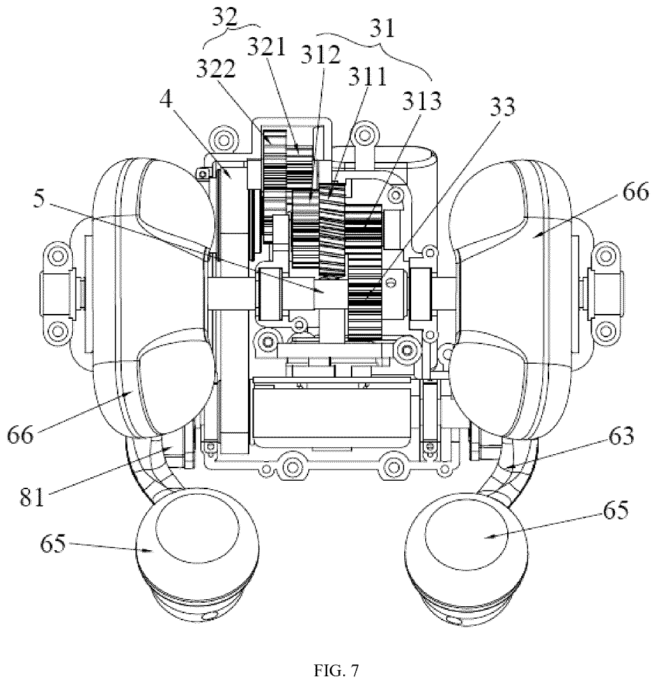

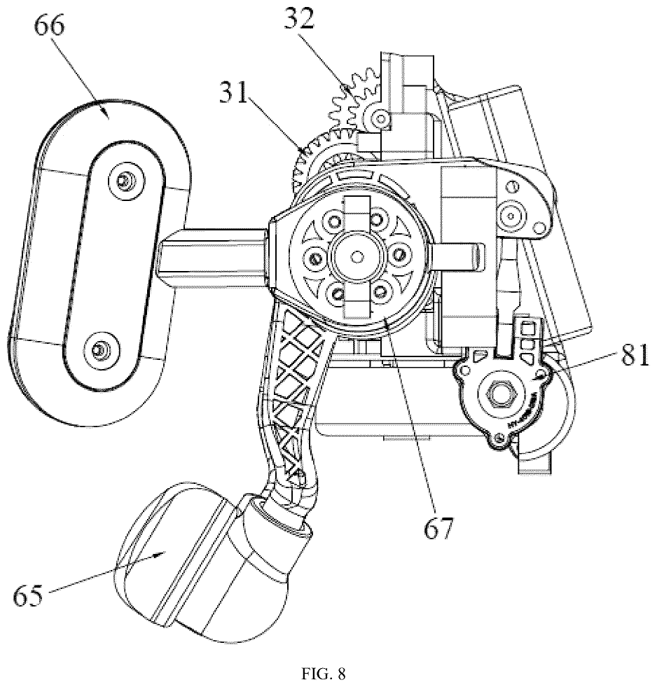

As shown in FIGS. 5-6, when the gimbal 631 is swung up to the highest point, the distance between the first massage head 65 and the second massage head 66 is the greatest, and the current state is the open state during use; as shown in FIGS. 7-8, when the gimbal 631 is swung down to the lowest point, the distance between the first massage head 65 and the second massage head 66 is the smallest, and the current state is the closed state (i.e., the clamping state) during use.

When the motor 2 rotates in a reverse direction, the output shaft 21 of the motor 2 drives the triple gear 31 to rotate. One end of the triple gear 31 drives the kneading shaft 5 to rotate, which in turn drives the eccentric wheel 61 and the deflection wheel 62 to rotate. This, in turn, drives the first massage head bracket 63 and the second massage head bracket 64 to rotate. The limit rod 641 at the bottom of the second massage head bracket 64, constrained by the limit groove 16 of the limit seat 15, enables the second massage head 66 on the second massage head bracket 64 to perform a deflection action within a certain range. At the same time, the other end of the triple gear 31 drives the tapping gear 34 and the connecting shaft 9 to rotate. During this process, the one-way needle roller bearing 43 also rotates simultaneously. At this point, the transmission process of the second transmission mechanism 4 involves acceleration (the brushless speed is about 2000 rpm, the speed for kneading and clamping is approximately 35 rpm, and for kneading and tapping, the speed is 35 rpm with approximately 300 taps). Since the tapping rod 82 is connected with the gimbal 631, the tapping rod 82, driven by the second transmission mechanism 4, causes the gimbals 631 on both sides of the kneading shaft 5 to perform up-down swing actions. The swing speed synchronizes with the speed of the multi-wedge belt 41, and the speed is accelerated to perform the tapping action.

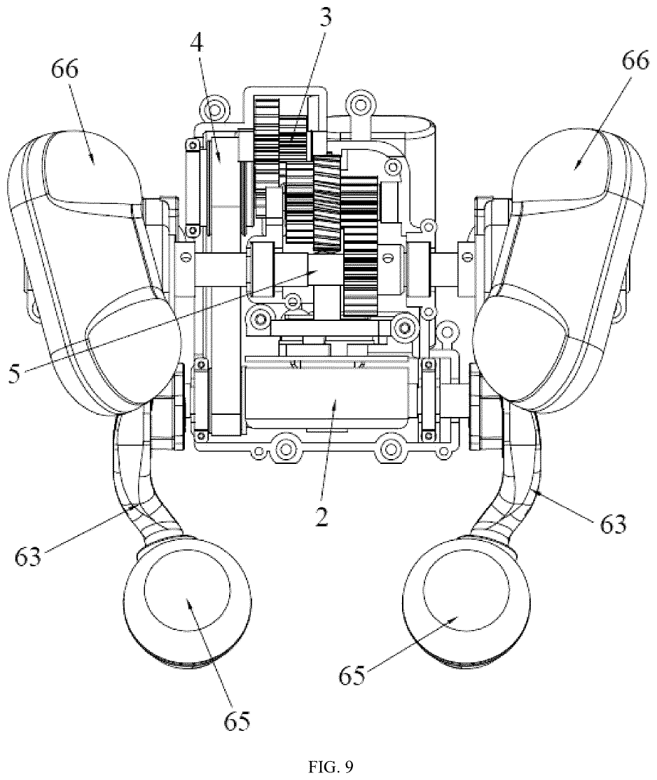

As shown in FIGS. 9-12, when the motor 2 rotates in the reverse direction, the up-down swing speed of the gimbal 631 of the first massage head bracket 63 synchronizes with the transmission speed of the multi-wedge belt 41, but it differs from the speed of the second massage head bracket 64, so that the first massage head bracket 63 drives the first massage head 65 to perform the same opening and clamping actions. Additionally, due to the accelerated transmission of the multi-wedge belt 41, the first massage head bracket 63 can also drive the first massage head 65 to perform the tapping action simultaneously.

That is, when the one-way needle roller bearing 43 is stuck, the transmission speeds of the first transmission mechanism 3 and the second transmission mechanism 4 are kept consistent, the massage speeds of the first massage head bracket 63 and the second massage head bracket 64 are kept consistent, so that the first massage head 65 and the second massage head 66 perform the massage action of kneading and clamping without performing the tapping massage; when the one-way needle roller bearing 43 rotates, the second transmission mechanism 4 performs an accelerating movement, so that the tapping rod 82 drives the first massage head bracket 63 to accelerate the up-down swing, and the massaging action of the massage machine core 10 combines kneading, clamping, and tapping, with approximately 35 rotations of kneading and around 300 taps per minute.

In this embodiment, the outer upper shell 11 of the machine core shell 1 is provided with four massage head holes 111 for the first massage heads 65 and the second massage heads 66 to protrude out, the four massage head holes 111 are provided with buffer sleeves 112 respectively, and the first massage heads 65 and the second massage heads 66 protrude out of the buffer sleeves 112.

In the present embodiment, the first massage head 65 is detachably arranged on the first massage head bracket 63, an end of the first massage head bracket 63 is provided with a first insertion post 632, a bottom end of the first massage head 65 is provided with a first insertion hole 651 corresponding to the first insertion post 632, so that the first massage head bracket 63 and the first massage head 65 are detachably fitted together; the second massage head 66 is detachably arranged on the second massage head bracket 64, a top end of the second massage head bracket 64 is provided with a second insertion post 642, a bottom end of the second massage head 66 is provided with a second insertion hole 661 corresponding to the second insertion post 642, so that the second massage head bracket 64 and the second massage head 66 are detachably fitted together. The first massage head 65 and the second massage head 66 are arranged in a detachable structure to facilitate the installation of the first massage head 65 and the second massage head 66, and at the same time, it is also convenient to replace the massage heads. It is only necessary to design a plurality of groups of massage heads to replace the first massage head and the second massage head, so that the massage machine core has different massage effects during massage.

In the present embodiment, the gimbal 631 at the bottom of the first massage head bracket 63 is a split structure including a left gimbal 633 and a right gimbal 634 directly integrally formed or fixedly arranged with the first massage head bracket 63, and the left gimbal 633 and the right gimbal 634 are buckled together. A ball hole 635 for the gimbal ball 821 of the tapping rod 82 to fit is provided between the left gimbal 633 and the right gimbal 634, and the gimbal ball 821 is mounted in the ball hole 635.

In the present embodiment, the tapping seat 81 of the tapping module 8 is provided with a mounting hole 811, the mounting hole 811 sleeves a bearing 83, the bearing 83 is arranged on the tapping shaft 7, the tapping seat 81 is provided with a connecting seat 812, the connecting seat 812 is provided with a pivoting groove 813 where one end of the tapping rod 82 is rotatably connected, the one end of the tapping rod 82 is rotatably mounted on the pivoting groove 813 through a pivoting shaft 814.

During the operation of the massage machine core of the disclosure, the motor 2 operates to drive the rotation of the first transmission mechanism 3 and the second transmission mechanism 4. The first transmission mechanism 3 drives the rotation of the kneading shaft 5, the eccentric wheel 61, and the deflection wheel 62, which in turn drive the rotation of the first massage head bracket 63 and the second massage head bracket 64. The one-way needle roller bearing 43 of the second transmission mechanism 4 will choose to be stuck or rotate depending on the direction of rotation of the motor 2. When the one-way needle roller bearing 43 is stuck, the second transmission mechanism 4 transmits at the same speed as the first transmission mechanism 3, so that the first massage head bracket 63 and the second massage head bracket 64 drive the first massage head 65 and the second massage head 66 to move synchronously to carry out the massage action of kneading and clamping, and the tapping module 8 does not carry out the tapping action; when the one-way needle roller bearing 43 rotates, the multi-wedge belt 41 is driven to accelerate transmission, so that the tapping rod 82 drives the first massage head bracket 63 and the first massage head 65 to accelerate up-down swing, and the tapping action is carried out simultaneously in addition to the massage action of clamping and kneading by the second massage head 66.

The massage machine core of the disclosure can simultaneously drive the first massage head bracket 63 and the second massage head bracket 64 to carry out left-right and up-down deflection actions through a motor 2, so that the first massage head 65 and the second massage head 66 can complete the kneading and clamping action, and whether or not to perform the tapping action while applying kneading and clamping massage can be selected through the forward or reverse rotation of the motor 2. The overall structure is compact, the manufacturing cost is low, and the market competitiveness can be improved.

The embodiments and drawings described above are not intended to limit the form and pattern of the disclosure, and any changes or modifications may be made thereto by those skilled in the art without departing from the scope of the disclosure.

What is claimed is:

1. A massage machine core, comprising:
a machine core shell, having a battery and a central plate arranged therein;
a motor, arranged in the machine core shell, wherein the motor has an output shaft;
a first transmission mechanism, connected with the output shaft of the motor and a kneading shaft;
a second transmission mechanism, connected with the output shaft of the motor or the first transmission mechanism, wherein the second transmission mechanism comprises a multi-wedge belt, a one-way needle roller bearing pulley, a one-way needle roller bearing, and a small pulley, wherein the one-way needle roller bearing is arranged on a connecting shaft, the one-way needle roller bearing pulley sleeves the one-way needle roller bearing, the small pulley is arranged on a tapping shaft, a first end of the multi-wedge belt sleeves the one-way needle roller bearing pulley, and a second end of the multi-wedge belt sleeves the small pulley;
the kneading shaft, arranged in the machine core shell and connected with the first transmission mechanism;
two kneading modules, symmetrically arranged at two ends of the kneading shaft;
the tapping shaft, arranged within the machine core shell and connected with the second transmission mechanism;
two tapping modules, symmetrically arranged at two ends of the tapping shaft, wherein each of the two tapping modules is connected with each of the two kneading modules on the same side; and
the connecting shaft, arranged in parallel with the tapping shaft at an interval and connected with the first transmission mechanism or the output shaft of the motor.

2. The massage machine core according to claim 1, wherein each of the two kneading modules comprises an eccentric wheel, a deflection wheel, a first massage head bracket, a second massage head bracket, a first massage head, and a second massage head, wherein the eccentric wheel and the deflection wheel are fixedly arranged on the kneading shaft, the first massage head bracket rotatably sleeves the eccentric wheel or the deflection wheel, the second massage head bracket rotatably sleeves the deflection wheel or the eccentric wheel, a deflection slope between the first massage head bracket and the second massage head bracket is thin on a first side and thick on a second side; a top end of the first massage head bracket is provided with the first massage head, a bottom end of the first massage head bracket is provided with a gimbal; a top end of the second massage head bracket is provided with the second massage head, a bottom end of the second massage head bracket is provided with a limit post, the machine core shell is provided with a limit seat at a position corresponding to the limit post, and a limit groove is arranged on the limit seat for the limit post to move; and
each of the two tapping modules comprises a tapping seat and a tapping rod, wherein the tapping seat is eccentrically arranged on the tapping shaft corresponding to the first massage head bracket, a first end of the tapping rod is connected with the tapping seat, a second end of the tapping rod is provided with a gimbal ball, and the gimbal ball is rotatably arranged on the gimbal at the bottom end of the first massage head bracket.

3. The massage machine core according to claim 1, wherein the first transmission mechanism comprises a triple gear, a transmission gear, a kneading gear, and a tapping gear, wherein the triple gear comprises a helical gear engaged with the output shaft, a first spur gear engaged with the transmission gear, and a second spur gear engaged with the kneading gear, the kneading gear is fixedly connected with the kneading shaft, the transmission gear comprises a third spur gear engaged with the first spur gear, and a fourth spur gear engaged with the tapping gear, and the tapping gear is fixed on the connecting shaft.

4. The massage machine core according to claim 2, wherein the eccentric wheel is fixedly arranged on a side of the kneading shaft adjacent to a center, the first massage head bracket sleeves the eccentric wheel, the deflection wheel abuts on the kneading shaft outside the eccentric wheel, wherein the first massage head bracket is limited on the eccentric wheel, the second massage head bracket sleeves the deflection wheel, an outer end of the deflection wheel is limited by a deflection wheel fixing seat, wherein the second massage head bracket is limited on the deflection wheel, and the deflection wheel between the first massage head bracket and the second massage head bracket forms the deflection slope.

5. The massage machine core according to claim 2, wherein the gimbal at the bottom end of the first massage head bracket is a split structure comprising a left gimbal and a right gimbal directly integrally formed or fixedly arranged with the first massage head bracket, a ball hole for the gimbal ball of the tapping rod to fit is provided between the left gimbal and the right gimbal, and the gimbal ball is mounted in the ball hole.

6. The massage machine core according to claim 2, wherein the tapping seat of each of the two tapping modules is provided with a mounting hole, the mounting hole sleeves a bearing, the bearing is arranged on the tapping shaft, the tapping seat is provided with a connecting seat, the connecting seat is provided with a pivoting groove where the first end of the tapping rod is rotatably connected, the first end of the tapping rod is rotatably mounted on the pivoting groove through a pivoting shaft.

7. The massage machine core according to claim 2, wherein the first massage head is detachably arranged on the first massage head bracket, an end of the first massage head bracket is provided with a first insertion post, a bottom end of the first massage head is provided with a first insertion hole corresponding to the first insertion post, wherein the first massage head bracket and the first massage head are detachably fitted together; the second massage head is detachably arranged on the second massage head bracket, the top end of the second massage head bracket is provided with a second insertion post, a bottom end of the second massage head is provided with a second insertion hole corresponding to the second insertion post, wherein the second massage head bracket and the second massage head are detachably fitted together.

8. The massage machine core according to claim 7, wherein the machine core shell comprises an outer upper shell, an outer lower shell, an inner upper shell, and an inner lower shell, wherein the outer upper shell and the outer lower shell are buckled together, the inner upper shell and the inner lower shell are buckled together, the inner upper shell and the inner lower shell are arranged at a middle position within the outer upper shell and the outer lower shell, and the motor is mounted within the inner upper shell and the inner lower shell.

9. The massage machine core according to claim 8, wherein the outer upper shell of the machine core shell is provided with four massage head holes for the first massage heads and the second massage heads to protrude out, the four massage head holes are provided with buffer sleeves respectively, and the first massage heads and the second massage heads protrude out of the buffer sleeves.

10. A kneading and tapping massager, comprising the massage machine core according to claim 1, handle cloth covers, adjusting belts, and a control switch, wherein each side of the massage machine core is connected with each of the handle cloth covers, the control switch is arranged on one of the handle cloth covers and connected with the central plate in the massage machine core, and each of the adjusting belts is arranged on each of the handle cloth covers.
